(19) United States
(12) Patent Application Publication
(10) Pub. No.: US 2004/0102989 A1
(43) Pub. Date: May 27, 2004

(54) Online digital photograph processing system for digital camera rental system

(76) Inventors: Yang-Su Jang, Koyang-shi (KR); Seung-Hwan Kim, Suwon-shi (KR); Jin-Hong Kim, Seoul (KR); Sung-Hoon Lee, Seoul (KR)

Correspondence Address: Robert E. Bushnell, Suite 300, 1522 K Street, N.W., Washington, DC, 20005-1202, US

(21) Appl. No.: 10/611,922

(22) Filed: Jul. 3, 2003

(30) Foreign Application Priority Data
Nov. 21, 2002 (KR) P2002-72781

(51) Int. Cl. G06F 17/60

(52) U.S. Cl. 705/1

(57) ABSTRACT

Disclosed is an online digital photograph processing system allowing a customer of a lodging house and an amusement park to receive and see a photograph captured by a rented digital camera through an online communication means or a television (TV). To this end, the customer rents a digital camera terminal for wirelessly transmitting image data of a digital photograph captured by the customer, together with data of the terminal's identification number. An access point device receives the transmitted data and transmits it to a central management center through an intranet. The central management center generates a user identification number of the customer; stores it to be correlated with both the terminal identification number and the identification number of the room assigned to the customer; receives the data from the digital camera terminal through the intranet; stores the received data in such a manner that the digital photograph is correlated with the user identification number; and, in response to a photograph projection request from the customer through the intranet, transmits corresponding image data to an Internet television through the intranet. An Internet protocol (IP) set-top box provides a connection between the Internet television and the intranet. A photograph editing device, connected to the central management center, provides an online photograph editor to allow the customer to edit the digital photograph stored in the central management center through the intranet. A manager personal computer (PC) transmits details on the rental of the digital camera terminal and details on the room assignment in response to the customer's check-in to the central management center through the intranet.

### CLAIM OF PRIORITY

This application makes reference to, incorporates the same herein, and claims all benefits accruing under 35 U.S.C. § 119 from my application ON-LINE DIGITAL PICTURE PROCESSING SYSTEM FOR DIGITAL CAMERA RENTAL SYSTEM filed with the Korean Industrial Property Office on Nov. 21, 2002 and there duly assigned Serial No. 72781/2002.

### BACKGROUND OF THE INVENTION

1. Technical Field

The present invention relates to a digital camera rental system, and more particularly to a system for renting a digital camera to a customer at places such as a hotel and an amusement park.

2. Related Art

A digital camera stores image data of a digital photograph captured by the digital camera in an internal memory or a detachable memory card. The stored image data of the digital photograph can be transferred to a computer, or easily printed out using a printer.

Due to such benefits, the digital camera becomes increasingly popular. However, in the case where a user of the digital camera has no computer or printer, the user must store the captured image data in a recording medium such as a flash memory card, and then visit a photo studio to order prints thereof.

Photography is typically an essential activity of users who visit an amusement park such as a public park and a theme park. But it is not unusual for users to visit the amusement park without a digital camera.

In consideration of such a situation, it is necessary to provide such a service that the operator of the amusement park rents a digital camera to users so that the users can take a picture even though the users do not bring their own camera, and so that the users can print a desired captured photograph even though the users do not bring their own printer. That is, the provision of such a service allows users to rent a digital camera for capturing and printing a picture when they visit an amusement park, and also allows the park's operator to accommodate the users as well as obtain a new source of revenue.

A technology related to such a service was disclosed on Nov. 15, 2001, by U.S. Patent Application Publication No. 2001/0041987 A1 entitled “RENTAL SYSTEM, MA CHINE, AND METHOD FOR PROVIDING RENTAL ITEMS” listing the inventor as Kenzo Ichikawa (hereinafter referred to as Ichikawa '987). While Ickikawa '987 has merit, it is believed that Ichikawa '987 fails to meet potential demands of guests staying at a lodging house or hotel or motel, such as, for example, when a guest staying at a lodging house might want to see and appreciate a photograph captured by a rented digital camera through a television installed at a guest room, or when the guest wants to receive the digital photograph after returning home without carrying home a recording medium with the digital images stored thereon.

Exemplars of recent efforts pertaining to shopping with a wireless device or accessing a storage unit using the Internet are disclosed in U.S. Pat. No. 6,434,530 B1 for INTERACTIVE SHOPPING SYSTEM WITH MOBILE APPARATUS issued on Aug. 13, 2002 to Sloane et al. and U.S. Pat. No. 5,946,660 for AUTOMATED STORAGE SYSTEM issued on Aug. 31, 1999 to McCarty et al.

It is believed that Ichikawa '987, McCarty et al. '660, and Sloane et al. '530 fail to provide a guest with the ability to easily order and receive a souvenir incorporating a digital photograph captured by the guest so as to commemorate the event for a long time. While Ichikawa '987, McCarty et al. '660, and Sloane et al. '530 contain merit, it is believed that further improvements can be contemplated.

### SUMMARY OF THE INVENTION

Therefore, the present invention has been made in view of the foregoing situations, and the present invention provides an online digital photograph processing system whereby a guest who stays at a lodging house or hotel or motel can receive and view a photograph captured by a digital camera rented from a digital camera rental system, through a television (TV) or online communication.

The present invention provides an online digital photograph processing system whereby a guest of a lodging house or a user of an amusement park can easily order and receive a souvenir incorporating a digital photograph captured by a rented digital camera.

The present invention provides an online digital photograph processing system that comprises a digital camera terminal, an access point device, an Internet television (TV), an Internet protocol (IP) set-top box, a central management center, a photograph editing device, and a manager personal computer (PC). The digital camera terminal, rented to the customer, wirelessly transmits image data of a digital photograph captured by the customer, together with data of the terminal's identification number. The access point device receives the wirelessly transmitted data from the digital camera terminal and transmits the received data to a central management center through an intranet. The Internet television (TV) is installed at a guest room assigned to the customer and connected to the intranet through an Internet protocol (IP) set-top box so as to provide an Internet protocol (IP) network access to the customer. The Internet protocol (IP) set-top box provides a connection between the Internet television (TV) and the intranet. The central management center a) generates a user identification number of the customer, b) stores the generated user identification number in such a manner that it is correlated with both a terminal identification number of the digital camera terminal and an identification number of the guest room assigned to the customer, c) receives the transmitted data from the digital camera terminal through the intranet, d) stores the received data in such a manner that the digital photograph is correlated with the user identification number, and d), in response to a photograph projection request from the customer through the intranet, transmits image data of a corresponding digital photograph to the Internet television (TV) through the intranet. The photograph editing device is connected to the central management center and provides an online photograph editor to allow the customer to edit the digital photograph stored in the central 8 management center through the intranet. The manager personal computer (PC) transmits details on the rental of the digital camera terminal and details on the room assignment in response to the customer's check-in to the central management center through the intranet.

The present invention provides an online digital photograph processing system that comprises a digital camera terminal, an access point device, a central management center, a photograph editing device, and a manager personal computer (PC). The digital camera terminal is rented to the customer and wirelessly transmits image data of a digital photograph captured by the customer, together with data of the terminal's identification number. The access point device receives the wirelessly transmitted data from the digital camera terminal and transmits the received data to a central management center through an intranet. The central management center a) generates a user identification number of the customer, b) stores the generated user identification number in such a manner that it is correlated with both a terminal identification number of the digital camera terminal and an identification number of the guest room assigned to the customer, c) receives the transmitted data from the digital camera terminal through the intranet, d) stores the received data in such a manner that the digital photograph is correlated with the user identification number, and e), in response to a photograph projection request from the customer through the Internet, transmits image data of a corresponding digital photograph to a user personal computer (PC) of the customer through the Internet. The photograph editing device is connected to the central management center for providing an online photograph editor to allow the customer to edit the digital photograph stored in the central management center through the Internet. The manager personal computer (PC) transmits details on the rental of the digital camera terminal and details on the room assignment in response to the customer's check-in to the central management center through the intranet.

Preferably, the online digital photograph processing system further comprises an electronic commerce processing device connected to the central management center. The electronic commerce processing device combines order details corresponding to an ordering of a souvenir incorporating the customer's digital photograph performed through the intranet with the corresponding customer information stored in the central management center, and transmits the combined data, together with image data of a digital photograph selected by the customer, to an order processing system of a souvenir manufacturer corresponding to the product category of the souvenir.

In accordance with the principles of the present invention, as embodied and broadly described, the present invention provides a system for renting a digital camera from a lodging house having guest rooms, the system comprising: a digital camera terminal being rented to a customer, said digital camera terminal wirelessly transmitting data including at least a terminal identification number of said digital camera terminal and including image data of a digital photograph captured by the customer, said digital camera terminal including a digital camera; an access device receiving the wirelessly transmitted data from said digital camera terminal, said access device transmitting the data received from said digital camera terminal through an intranet; a central management center being in communication with the intranet, said central management center receiving from the intranet the data transmitted by said access device including the terminal identification number and the image data; an Internet television being connected to the intranet, said Internet television being installed at a guest room of a lodging house, said Internet television providing an Internet protocol network access to the customer; a set-top box providing a connection between said Internet television and the intranet; a management computer transmitting information to said central management center through the intranet when the customer is assigned the guest room of the lodging house, the information including the terminal identification number and a room identification number corresponding to the guest room assigned to the customer, said central management center storing the terminal identification number and the room identification number corresponding to the guest room assigned to the customer received from said management computer, said central management center generating a user identification number of the customer, said central management center storing the generated user identification number to correlate the generated user identification number at least with the terminal identification number and with the room identification number and with the image data, said central management center transmitting the image data to said Internet television through the intranet in response to a request for the digital photograph, the request for the digital photograph being from the customer and through the intranet; and an editor unit being connected to said central management center, said editor unit editing the digital photograph stored in said central management center, the editing being controlled by the customer through the intranet.

In accordance with the principles of the present invention, as embodied and broadly described, the present invention provides a system for renting a digital camera from a lodging house having guest rooms, the system comprising: a digital camera terminal being rented to a customer, said digital camera terminal wirelessly transmitting data including at least a terminal identification number of said digital camera terminal and including image data of a digital photograph captured by the customer, said digital camera terminal including a digital camera; an access device receiving the wirelessly transmitted data from said digital camera terminal, said access device transmitting the data received from said digital camera terminal through an intranet; a central management center being in communication with the intranet, said central management center receiving from the intranet the data transmitted by said access device including the terminal identification number and the image data; a management computer transmitting information to said central management center through the intranet when the customer is assigned a guest room of the lodging house, the information including the terminal identification number and a room identification number corresponding to the guest room assigned to the customer, said central management center storing the terminal identification number and the room identification number corresponding to the guest room assigned to the customer received from said management computer, said central management center generating a user identification number of the customer, said central management center storing the generated user identification number to correlate the generated user identification number at least with the terminal identification number and with the room identification number and with the image data, said central management center transmitting the image data to a user computer through the Internet in response to a request for the digital photograph, the request for the digital photograph being from the customer and through the Internet; and an editor unit being connected to said central management center, said editor unit editing the digital photograph stored in said central management center, the editing being controlled by the customer through the Internet.

In accordance with the principles of the present invention, as embodied and broadly described, the present invention provides a method for renting a digital camera from a lodging house having guest rooms, the method comprising: wirelessly transmitting from a digital camera terminal data including at least a terminal identification number of said digital camera terminal and including image data of a digital photograph captured by a customer, said digital camera terminal being rented to the customer and including a digital camera; receiving the wirelessly transmitted data at an access device; transmitting the data from said access device through an intranet; receiving from the intranet the data transmitted by said access device including the terminal identification number and the image data, said receiving of the data transmitted by said access device being performed by a central management center; and transmitting information from a management computer to said central management center through the intranet when the customer is assigned a guest room of the lodging house, the information including the terminal identification number and a room identification number corresponding to the guest room assigned to the customer, said central management center storing the terminal identification number and the room identification number corresponding to the guest room assigned to the customer received from said management computer, said central management center generating a user identification number of the customer, said central management center storing the generated user identification number to correlate the generated user identification number at least with the terminal identification number and with the room identification number and with the image data.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a block view showing an online digital photograph processing system, in accordance with the principles of the present invention; and

FIG. 2 is a flowchart illustrating the operation procedure of a central management center of FIG. 1, in accordance with the principles of the present invention.

### DESCRIPTION OF BEST MODE OF CARRYING OUT THE INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description of the best mode contemplated of carrying out the invention, which follows, is to be understood as being a broad, teaching disclosure directed to persons of skill in the appropriate arts, and not as limiting upon the present invention.

Illustrative embodiments of the best mode of carrying out the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

First, a system similar to or related to Ichikawa '987 shall be described. The Ichikawa-related system does not include all the advantages of the present invention, but the following description may help to show the problems which are solved by the present invention. The Ichikawa-related system is a system that pertains to automatically renting items such as a digital camera to a user of an amusement or theme park, or a guest of a hotel, and for managing them. In the Ichikawa-related system, the user can rent a digital camera from an automatic renting machine, take a picture using the camera, and return it to the machine after finishing the use of the digital camera. A plurality of automatic renting machines are installed in specific areas, and connected to a management center through a dedicated line or a wireless network. The digital camera can be connected to a cellular phone so as to transmit the captured image data to the management center through the cellular phone. The management center transmits the received image data back to the automatic renting machine, and this machine stores the received image data. The digital camera may include a data transmitter so as to transmit the captured image data to the renting machine through a personal handyphone system (PHS) communication network. In this case, the automatic renting machine receives the image data from the digital camera via a data receiver, and stores the received data.

In the Ichikawa-related system, in the case where the user requests the printing of the captured picture while returning the camera, the automatic renting machine or the management system prints an image corresponding to the stored image data, and provides it to the user. During this camera returning procedure, the rental fee payment process is performed. However, in the case where the user is a guest of a hotel, the rental fee payment is made together with the hotel fee payment at the time of checking out of the hotel. This fee payment process is performed via a financial institution such as a credit card company.

Also, in the above-described system, the rental and return of the digital camera can be handled by a person in charge at the front desk of the hotel, the fee payment process is performed via a financial institution which the user uses for paying the service charges of her or his cellular phone, and the captured image data is recorded on a recording medium such as a compact flash card or floppy disk so as to be provided to the user or hotel guest.

As mentioned above, according to the above-described system, the park user or lodging house guest can rent a digital camera for capturing and printing a picture, and can be provided with a recording medium stored with a digital photograph, thereby allowing the park or hotel to accommodate the users as well as obtain a new source of revenue.

It is believed that Ichikawa '987, McCarty et al. '660, and Sloane et al. '530 fail to meet potential demands of a guest, and it is believed that the above-described beta system fails to meet potential demands of a guest. For example, when a guest staying at a lodging house or hotel or motel desires to see and appreciate a photograph captured by a rented digital camera through a television (TV) installed at a guest room, Ichikawa '987, McCarty et al. '660, and Sloane et al. '530 fail to satisfy the desires of the guest, and the above-described beta system fails to satisfy the desires of the guest. Also, when a guest staying at a lodging house desires to receive the digital photograph after returning home without bringing home a recording medium with the digital images stored thereon, Ichikawa '987, McCarty et al. '660, and Sloane et al. '530 fail to satisfy the desires of the guest, and the above-described beta system fails to satisfy the desires of the guest.

In addition, Ichikawa '987, McCarty et al. '660, Sloane et al. '530, and the above-described beta system fail to provide a guest with the ability to easily order and receive a souvenir incorporating a digital photograph captured by the guest so as to commemorate the event for a long time.

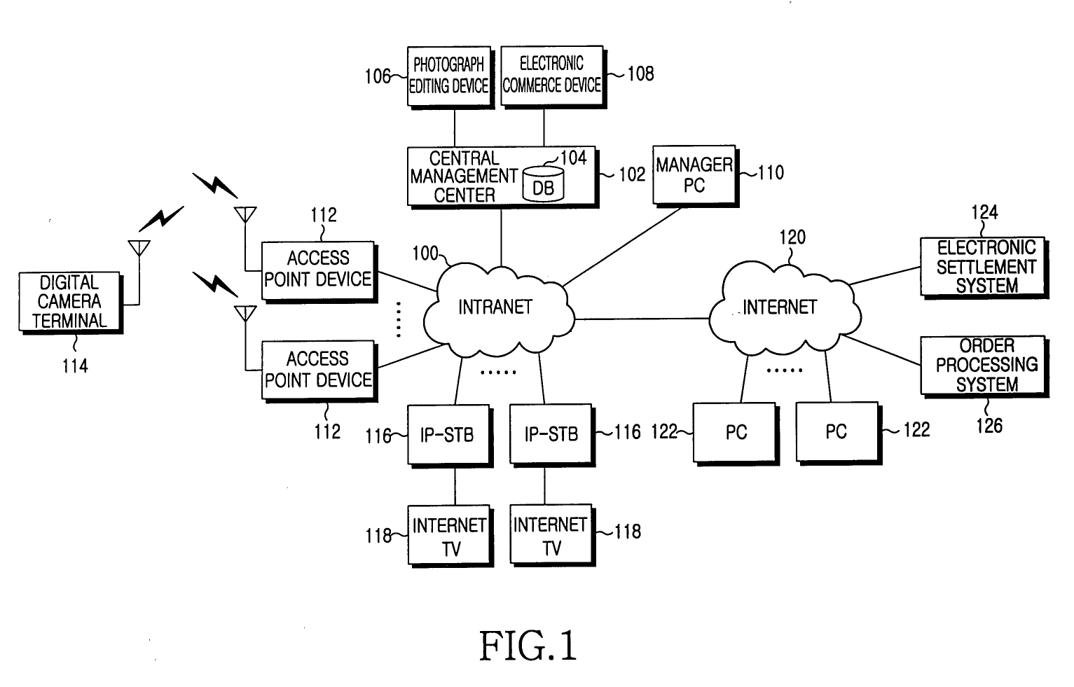

FIG. 1 is a block view showing an online digital photograph processing system, in accordance with the principles of the present invention. Referring to FIG. 1, the online digital photograph processing system provides an online digital photograph processing service according to the present invention to a customer who uses an amusement park affiliated with a lodging house such as a hotel at which the customer stays.

In the online digital photograph processing system, a central management center 102, a manager personal computer (PC) 110, a plurality of access point devices 112, and a plurality of Internet protocol set-top boxes (IP-STBs) 116 are connected to an intranet 100 installed at a lodging house or hotel or motel. The access point device 112 can be referred to as an access device 112. The term “lodging house” can refer to a hotel, motel, condominium, townhouse, single family home, or any other rental unit where a person may stay.

A lodging house can be said to be affiliated with an amusement park in a wide variety of circumstances. Some examples of affiliations are offered herein, but these examples are not intended to explicitly list every possible type of affiliation. A lodging house is affiliated with an amusement park if they are both owned by the same government, corporation, partnership, group, or individual. A lodging house is affiliated with an amusement park if they have reached some type of agreement to be affiliated with each other. A lodging house is affiliated with an amusement park if the lodging house sells tickets for admission to the amusement park, or sells tickets for services or products provided at the amusement park. A lodging house is affiliated with an amusement park if one or both offer some type of discount at the other. A lodging house can be affiliated with an amusement park when they are located within the same general vicinity. A lodging house can be affiliated with an amusement park when the lodging house offers to provide transportation to the amusement park. A lodging house is affiliated with an amusement park if the lodging house is located on property owned by the amusement park or leased to the amusement park or under the control of the amusement park. A lodging house is affiliated with an amusement park if the amusement park is located on property owned by the lodging house or leased to the lodging house or under the control of the lodging house. The examples of affiliations shown herein are not offered to limit the definition of the term affiliation, but are merely offered to help show some examples of possible affiliation arrangements.

The terms “amusement park” and “theme park” can refer to a region including a roller coaster ride, a water slide, animals, a juggler, a movie, food, beverages, for example. The use of the present invention is not limited to amusement parks.

The Internet protocol set-top box 116 is able to use Internet protocol, is able to access the intranet 100, is able to transmit information to the intranet 100, and is able to receive information from the intranet 100. The Internet protocol set-top box 116 can also be referred to as a set-top box 116.

A set-top box can correspond to a device able to perform various functions. For example, a set-top box can support Internet access through a television, and can provide users with high-speed access to the Internet via a cable modem or broadband network rather than the traditional telephone network plain old telephone services (POTS). In addition, a set-top box can provide video-conferencing capabilities, can support community networking, and can provide media-on-demand (MOD) capabilities including video-on-demand, music-on-demand, news-on-demand, impulse-pay-per-view, and television-programs-on-demand. A set-top box is often located at a remote user location enabling the user to transmit information signals such as requests, instructions, or other data. A set-top box can include a central processing unit.

The manager personal computer 110 can be a desktop computer or a portable computer or any other type of computer. For example, the manager personal computer 110 can be a notebook computer, tablet computer, wearable computer, hand-held computer, palm-sized computer, personal digital assistant (PDA), or other type of computer, or any device having computer data processing capabilities, or any other device that can access the intranet 100 and perform the other functions of the manager personal computer 110 as described herein. The manager personal computer 110 can also be referred to as a management computer 110.

A photograph editing device 106 and an electronic commerce processing device 108 are connected to the central management center 102. The plurality of access point devices 112 are connected to a digital camera terminal 114. The plurality of Internet protocol set-top boxes (IP-STBs) 116 are connected to a plurality of respective Internet televisions (TVs) 118. The photograph editing device 106 can also be referred to as an editor unit 106. The electronic commerce processing device 108 can also be referred to as a commerce unit 108.

The central management center 102 is connected to a plurality of user personal computers (PCs) 122, an electronic settlement system 124, and an order processing system 126 through the Internet 120 connected to the intranet 100. The Internet 120 is an international network of computers which can be accessed by the use of a web browser such as Microsoft(R) Internet Explorer or Netscape(R) Navigator, for example. In general, the Internet 120 is also referred to as the World Wide Web or simply the web.

The personal computer (PC) 122 can be a desktop computer or a portable computer or any other type of computer. For example, the personal computer 122 can be a notebook computer, tablet computer, wearable computer, hand-held computer, palm-sized computer, personal digital assistant (PDA), or other type of computer, or any device having computer data processing capabilities, or any other device that can access the Internet 120 and perform the other functions of the personal computer 122 as described herein. The personal computer 122 can also be referred to as a user computer 122.

The digital camera terminal 114 is rented to a guest staying at the lodging house or hotel or motel. FIG. 1 shows only one digital camera terminal 114 for convenience of illustration, but a plurality of terminals 114 maybe rented to guests. The digital camera terminal 114 is a digital camera that includes a data transmitter to wirelessly transmit image data of a digital photograph captured by the customer, together with data of its terminal identification number. The digital camera terminal 114 includes a digital camera.

The terminal identification number is a management number uniquely assigned to each of the digital camera terminals 114 for its identification. The access point devices 112, which are usually used for connecting a wireless terminal device to a wired network, receives the wirelessly transmitted data from the digital camera terminal 114, and transmits the received data to the central management center 102 through the intranet 100.

The access point devices 112 are installed in a lodging house or its affiliated amusement park or both, and the number of installations and their positions are determined to allow the devices 112 to wirelessly receive data from the terminals 114 no matter where the customer moves carrying the terminal 114 inside the lodging house or its affiliated amusement park.

The Internet television (TV) 118 is installed at each of guest rooms of the lodging house, and is connected to the intranet 100 through its corresponding Internet protocol set-top box (IP-STB) 116. Each guest room has a room number or other room identification number. Because the Internet televisions (TVs) 118 are connected to the intranet 100 through the Internet protocol set-top boxes (IP-STBs) 116 which usually allows the Internet televisions (TVs) 118 to gain access to an Internet protocol (IP) network, a customer who stays at the corresponding guest room can gain access to the Internet protocol (IP) network through the Internet television (TV) 118.

The central management center 102 is, for example, a computer center, and has a customer management database (DB) 104. This center 102 is connected to the intranet 100, and manages the overall customer service matters such as the customer's reservation, check-in, staying, and check-out, as well as post checkout matters. The database (DB) 104 stores, for example, a room reservation status file, a customer information file, an identification number management file, and a picture file.

A check-in process at a lodging house or hotel usually requires that a customer provide information to a sales agent or representative of the lodging house. During a check-in process on the day that the customer arrives at the lodging house, the customer may provide the following information to a representative of the lodging house: the name of the customer, the address of customer, credit card information, and expected date of departure from the lodging house. During the check-in process, the representative typically will assign a guest room to the customer, present a contract to the customer and ask for the customer's signature. After the contract is signed, the representative provides the customer with a key or magnetic access card in order to enable the customer to enter the assigned guest room. In some cases, the magnetic access card can be used as a special credit card.

Before the check-in process, during the check-in process, or even after the check-in process, the customer may decide to rent a digital camera terminal 114 from the lodging house, or from an amusement park or other region affiliated with the lodging house. The customer can begin the rental of the digital camera terminal 114 prior to check-in at the lodging house. That is, the customer can enter into a rental agreement for the digital camera terminal 114 prior to check-in at the lodging house.

A check-out process at a lodging house can include the customer returning the key or access card to a representative of the lodging house and signing a credit card receipt with the total amount due for the guest room, telephone calls, room service, restaurant services, rented movies, and any other charges incurred during the customer's stay at the lodging house. During the check-out process, a rented digital camera terminal 114 can be returned to the representative of the lodging house. An alternative arrangement can be established to allow the customer to return the rented terminal 114 to the affiliated region or to the affiliated amusement park, so that the customer does not need to return the rented terminal 114 to the representative of the lodging house. Also, the customer may return the rented terminal 114 prior to the check-out process or after the check-out process.

The room reservation status file is composed of information of reservation statuses of guest rooms. The customer information file is composed of personal information, settlement information, and transaction history information of customers who reserved a room, currently stay or have stayed at the lodging house. The identification number management file is composed of information such as a user identification number, a reservation identification number, a room identification number, and a terminal identification number. The picture file is composed of digital photographs that are captured by the digital camera terminals 114 and received by the central management center 102 through the access point devices 112 and the intranet 100, or image data of a digital photograph edited by the customer using the photograph editing device 106.

The photograph editing device 106 is connected to the central management center 102, and provides an online photograph editor so that the customer can edit a digital photograph stored in the central management center 102 using the online photograph editor after establishing a connection to the central management center 102 through the intranet 100 using the Internet television (TV) 118, or through the Internet 120 using the user personal computer (PC) 122 from the customer's residence or office. The electronic commerce processing device is connected to the central management center 102 to perform an electronic commerce process according to the ordering of a souvenir incorporating the customer's digital photograph which the customer requests after establishing a connection to the central management center 102 using the Internet television (TV) 118 from the guest room through the intranet 100, or using the user personal computer (PC) 122 from the customer's residence or office through the Internet 120.

The electronic commerce processing device 108 combines order details according to the ordering of the souvenir incorporating the customer's digital photograph with the corresponding customer information stored in the central management center 102, and transmits the combined data, together with image data of a digital photograph selected by the customer, to an order processing system 126 of a souvenir manufacturer corresponding to the product category of the souvenir, through the center management center 102 via the Internet 120. FIG. 1 shows, as an example, that the photograph editing device 106 and the electronic commerce processing device 108 are composed of separate dedicated servers connected to the central management center 102, but, instead, they can be incorporated in the central management center 102.

The manager personal computer (PC) 110 is installed, for example, at a front desk of a lodging house, and a management office of an amusement park affiliated with the lodging house, and transmits details on room assignments according to check-ins of customers, and details on the rental of digital camera terminals 114 to the central management center 102 through the intranet 100. In addition, the manager personal computer (PC) 110 transmits details on usages of various facilities or items of the lodging house or the amusement park affiliated with the lodging house during the stay of the customers to the central management center 102 through the intranet 100. When a customer checks out, the manager personal computer (PC) 110 receives and prints the details on usages of products and services during the stay of the customer from the central management center 102 through the intranet 100.

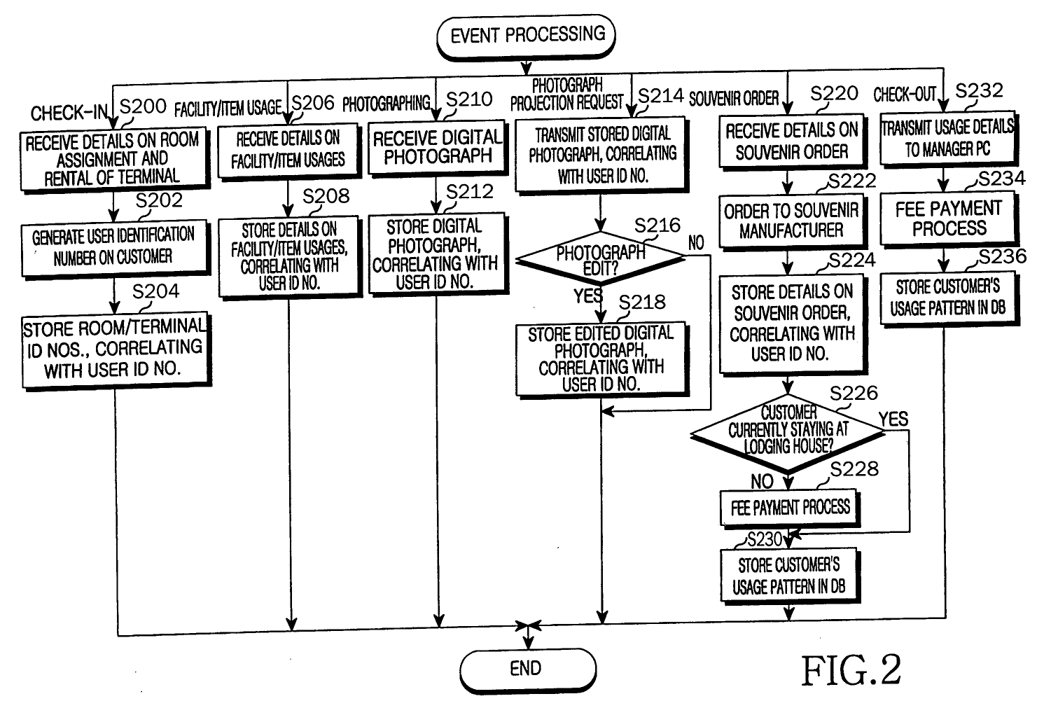

FIG. 2 is a flowchart illustrating the operation procedure of a central management center of FIG. 1, in accordance with the principles of the present invention. FIG. 2 is a flowchart illustrating the operation procedure, steps S200 to S236, of the central management center 102, in accordance with the principles of the present invention. Now, referring to FIG. 2, an example of the operation of the central management center 102 is described in detail in which the center 102 performs processes of various events for providing an online digital photograph processing service according to an embodiment of the present invention.

Portions of an event process related to the customer's reservation or check-in are omitted in the following description when those portions are similar to a general customer reservation or check-in process utilized when a customer makes a reservation or checks into a hotel. When a customer visits a lodging house or hotel and checks in, a person in charge at the front desk inquires of the central management center 102 about the customer's reservation status using the manager personal computer (PC) 110, and then assigns a guest room to the customer.

At this time, if the customer requests to rent a digital camera terminal 114, the person in charge rents the terminal 114 to the customer. When the guest room is assigned to the customer according to the check-in and the digital camera terminal 114 is rented to the customer as mentioned above, the manager personal computer (PC) 110 transmits details on the room assignment and details on the rental of the digital camera terminal 114 to the central management center 102 through the intranet 100 according to the PC's manipulation by the person in charge.

Accordingly, at step S200, the central management center 102 receives the details on the room assignment and the rental of the digital camera terminal 114 from the manager personal computer (PC) 110 through the intranet 100. At step S202, the central management center 102 generates a user identification number for the corresponding customer. At step S204, the central management center 102 stores both a terminal identification number of the digital camera terminal 114 rented to the customer and a room identification number of the room assigned to the customer in the database (DB) 104 in such a manner that they are correlated with the generated user identification number.

Each time the checked-in customer uses a charged facility or item in the lodging house, or enters its affiliated amusement park and then uses its charged facility or item, a person in charge of the lodging house or the amusement park transmits details on the customer's usage of the facility or item to the central management center 102 using the manager personal computer (PC) 110. At step S206, the central management center 102 receives various product and service usage details of the customer from the manager personal computer (PC) 110 through the intranet 100. At step S208, the central management center 102 stores the received details in the database (DB) 104, correlating it with the user identification number of the corresponding customer.

When a customer captures a picture using a rented digital camera terminal 114 in the lodging house or its affiliated amusement park, the terminal 114 wirelessly transmits image data of the captured digital photograph, together with data of the terminal identification number. The data from the terminal 114 is transmitted to the central management center 102 through an access point device 112 positioned near the terminal 114 via the intranet 100. At step S210, the central management center 102 receives the data transmitted from the terminal 114 via the intranet 100. At step S212, the central management center 102 stores the image data of the digital photograph contained in the received data in the database (DB) 104, correlating it with a user identification number referenced by the terminal identification number contained in the received data.

After the customer captures a picture using the digital camera terminal 114 in the lodging house or its affiliated amusement park as mentioned above and then returns to the guest room, the customer can see and appreciate the captured digital photograph using the Internet television (TV) 118 installed at the guest room. To this end, the customer requests the photograph projection after establishing a connection to the central management center 102 through the Internet protocol set-top box (IP-STB) 116 and the intranet 100 by manipulating the Internet television (TV) 118 from the guest room. In addition, even after check-out, the customer can request the photograph projection after establishing a connection to the central management center 102 through the Internet 120 using the personal computer (PC) 122 from the customer residence or office.

At step S214, in response to the photograph projection request from the customer, the central management center 102 transmits a digital photograph stored in the database (DB) 104 that is correlated with a user identification number of a customer represented by the identification number of the guest room, at which the corresponding Internet television (TV) 118 is installed, to the corresponding Internet television (TV) 118 through the intranet 100, or the center 102 transmits a digital photograph stored in the database (DB) 104, correlated with a user identification number referenced by customer personal information input through the user personal computer (PC) 122, to the personal computer (PC) 122 via the Internet 120 connected to the intranet 100. Then, the photograph captured by the customer is displayed on the screen of the Internet television (TV) 118 installed at the customer's guest room, or on the monitor of the personal computer (PC) 122.

Accordingly, the customer can see and appreciate the photograph displayed on the Internet television (TV) 118 or the monitor of the personal computer (PC) 122, and can edit it, or store it in the personal computer (PC) 122. At step S216, to this end, the customer manipulates the Internet television (TV) 118 or the personal computer (PC) 122 to select an online photograph editor. At step S218, in response to the selection of step S216, the central management center 102 provides the online photograph editor through the photograph editing device 106. When the customer edits the photograph using the online photograph editor, the central management center 102 stores the edited digital photograph in the database (DB) 104, correlating it with the user identification number.

Also, the customer can order a souvenir incorporating his or her own digital photograph, for example, an electronic album, or various items printed with the digital photograph. In order to make a souvenir order, the customer manipulates the Internet television (TV) 118 to establish a connection to the central management center 102 through the intranet 100, and then select a desired digital photograph and a desired souvenir item.

In addition, even after check-out, the customer can order the souvenir by selecting a desired digital photograph and a desired souvenir item after establishing a connection to the center 102 through the Internet 120 using the user personal computer (PC) 122 from the customer's residence or office. At step S220, in response to this request, the central management center 102 receives the souvenir order details from the Internet television (TV) 118 through the intranet 100, or receives them from the personal computer (PC) 122 through the Internet 120. At step S222, the central management center 102 combines the order details of the customer with the corresponding customer information stored in the center 102 using the electronic commerce processing device 108, and transmits the combined data, together with image data of a digital photograph selected by the customer, to the order processing system 126 of a souvenir manufacturer corresponding to its product category through the Internet 120.

After receiving the ordering of the souvenir incorporating the customer's digital photograph, the souvenir manufacturer manufactures the souvenir and sends it to the customer. At step S224, the central management center 102 stores usage details corresponding to the souvenir order as transaction history information in the database (DB) 104, correlating it with the user identification number. At step S226, a determination is made to check whether the corresponding customer stays at the corresponding lodging house. At step S228, if the checked result is not affirmative, that is, in the case where the customer checked has out and gains access to the central management center 102 using the personal computer (PC) 122, the fee payment process is performed. This fee payment process is performed in such a manner that, similar to the general electronic settlement, the central management center 102 bills a financial institution such as a credit card company for the charges after establishing a connection to the electronic settlement system 124 of the financial institution through the Internet 120, and the payment by the customer is separately made between the customer and the financial institution.

At step S230, the usage pattern of the customer is databased, and stored in the database (DB) 104 to be added to the transaction history information. On the contrary, when the checked result of step S226 is affirmative such that the corresponding customer still stays at the lodging house, the step S230 is performed without the fee payment process of step S228 because the fee payment process is to be performed later at a time of check-out as mentioned below.

When the customer checks out, the person in charge of the lodging house requests the customer's usage details from the central management center 102 using the management personal computer (PC) 110 through the intranet 100. At step S232, in response to this request, the central management center 102 transmits the details on usages of products and services during the staying period of the customer, stored in the database (DB) 104, to the manager personal computer (PC) 110 through the intranet 100. The usage details contains at least one of details on usages of products and services in the lodging house, usages of products and services in the amusement park affiliated with the lodging house, the rental of the digital camera terminal 114, and the ordering of a souvenir.

The manager personal computer (PC) 110 outputs the details on usages of products and services during the staying period of the customer that is received from the central management center 102, and provides the usage details to the customer. At step S234, the manager personal computer (PC) 110 performs a fee payment process as in step S238. At step S236, the usage pattern of the customer is databased, and stored in the database (DB) 104 to be added to the transaction history information.

As apparent from the above description, according to the present invention, a customer using a lodging house and its affiliated amusement park can see and appreciate or edit a photograph captured by a rented digital camera terminal by displaying it on a television (TV) at his or her guest room, and, even after check-out, the customer can receive the photograph through an online communication means to see and appreciate or edit it. In addition, the customer can easily order and receive a souvenir incorporating the digital photograph captured by herself or himself. Accordingly, the present invention can improve the convenience of customers, and attract more customers.

Although embodiments setting forth the best mode of carrying out the present invention have been disclosed for illustrative purposes, various modifications, additions and substitutions are possible without departing from the scope of the invention. For example, although the best mode has been described as an example for the case of providing all of the services to allow the customer to receive the photograph captured by a rented digital camera terminal, and to allow the customer to receive the photograph through an online communication means after check-out, and to further allow the customer to order and receive a souvenir incorporating the digital photograph captured by the customer, it is also possible to selectively provide more than one of the services. In addition, a personal computer (PC) may be installed and used at the guest room, instead of the Internet television (TV) 118, an Internet television (TV) may be used at the customer's residence or office, instead of the personal computer (PC) 122, and the manager personal computer (PC) 110 can be replaced with a dedicated terminal. Further, the electronic commerce processing device 108 and the order processing system 126 may be connected to each other through a dedicated line, instead of the Internet 120.

The present invention can be utilized in a wide variety of different types of regions. One type of region includes an amusement park and a theme park. That is, the present invention can be utilized at a hotel affiliated with an amusement park, with access point devices 112 installed at the hotel and throughout the amusement park, as described above.

In accordance with the principles of the present invention, a lodging house can be said to be affiliated with a region or area that is not an amusement park. The affiliated region or area can include a mountain, beach, ski resort, golf resort, farm, desert, historic area, rural area, museum, city, or memorial, for example. Thus, access point devices 112 can be located at the lodging house and at a number of different locations in the affiliated region or nearby region.

Because the present invention can be utilized in a wide variety of different types of regions, the types of regions can include an entertainment area, a destination of tourists, any destination of anyone seeking entertainment, diversion, or sustenance, or any other region. Thus, the present invention can be utilized at a lodging house affiliated with or located near a mountainous region, a museum, a city, or a memorial, for example. The present invention can be utilized at a lodging house affiliated with or located near to a golf resort, ski resort, or a beach, for example. People sometimes go to see historic areas, rural areas, deserts, farms, or waterfalls, for diversion or contemplation or exploration or for other reasons, and the present invention can be utilized at those types of regions also, and many other types of regions.

For example, the present invention can be utilized at a hotel affiliated with a ski resort, with access point devices 112 installed at the hotel and throughout the ski resort. Access point devices 112 can be installed at many different locations of a ski resort. Here are some possible reasons why a lodging house may be said to be affiliated with a ski resort. A lodging house is affiliated with a ski resort if they are both owned by the same government, corporation, partnership, group, or individual. A lodging house is affiliated with a ski resort if they have reached some type of agreement to be affiliated with each other. A lodging house is affiliated with a ski resort if the lodging house sells tickets for admission to the ski resort or for services provided at the ski resort. A lodging house is affiliated with a ski resort if one or both offer some type of discount at the other. A lodging house can be affiliated with a ski resort when they are located within the same general vicinity. A lodging house can be affiliated with a ski resort when the lodging house offers to provide transportation to the ski resort. A lodging house is affiliated with a ski resort if the lodging house is located on property owned by the ski resort or leased to the ski resort or under the control of the ski resort. A lodging house is affiliated with a ski resort if the ski resort is located on property owned by the lodging house or leased to the lodging house or under the control of the lodging house.

Access point devices 112 can be installed at a lodging house and at many different locations surrounding a mountain and at the top of the mountain. Here are some possible reasons why a lodging house may be said to be affiliated with a mountain. A lodging house can be affiliated with a mountain if they are both owned by the same government, corporation, partnership, group, or individual. A lodging house can be affiliated with a mountain if the lodging house sells tickets for transportation to the mountain or for services provided at the mountain.

Access point devices 112 can be installed at a lodging house and at many different locations near a beach. Here are some possible reasons why a lodging house may be said to be affiliated with a beach. A lodging house can be affiliated with a beach if they are both owned by the same government, corporation, partnership, group, or individual. A lodging house can be affiliated with a beach if the lodging house sells tickets for transportation to the beach or for services provided at the beach.

The principles of the present invention will also apply if the access point devices 112 are located over a large range of territory. When the principles of the present invention are applied over a large range of territory, the intranet 100 can be replaced by Internet 120. Also, an additional embodiment of the present invention dictates that the intranet 100 is replaced by the Internet 120, even when the access point devices 112 are only located throughout an amusement park and an affiliated lodging house.

The access point devices 112 can be positioned in different portions of the world, in Asia, Europe, Australia, Africa, North America, Central America, and South America, for example, so that a person renting the digital camera terminal 114 can travel to those places and conveniently have the digital images stored at the central management center 102, and have the convenience of the principles of the present invention when that person returns the rented terminal 114.

Instead of placing the devices 112 all over the world, the access point devices 112 can be located at one region and can be designed to communicate with the digital camera terminal 114 through satellites, not shown in the drawings. This would also allow a person renting the digital camera terminal 114 to travel to different places in the world and conveniently have the digital images stored at the central management center 102, and have the convenience of the principles of the present invention when that person returns the rented terminal 114.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A system for renting a digital camera from a lodging house having guest rooms, the system comprising:
a digital camera terminal being rented to a customer, said digital camera terminal wirelessly transmitting data including at least a terminal identification number of said digital camera terminal and including image data of a digital photograph captured by the customer, said digital camera terminal including a digital camera;
an access device receiving the wirelessly transmitted data from said digital camera terminal, said access device transmitting the data received from said digital camera terminal through an intranet;
a central management center being in communication with the intranet, said central management center receiving from the intranet the data transmitted by said access device including the terminal identification number and the image data;
an Internet television being connected to the intranet, said Internet television being installed at a guest room of a lodging house, said Internet television providing an Internet protocol network access to the customer;
a set-top box providing a connection between said Internet television and the intranet;
a management computer transmitting information to said central management center through the intranet when the customer is assigned the guest room of the lodging house, the information including the terminal identification number and a room identification number corresponding to the guest room assigned to the customer, said central management center storing the terminal identification number and the room identification number corresponding to the guest room assigned to the customer received from said management computer, said central management center generating a user identification number of the customer, said central management center storing the generated user identification number to correlate the generated user identification number at least with the terminal identification number and with the room identification number and with the image data, said central management center transmitting the image data to said Internet television through the intranet in response to a request for the digital photograph, the request for the digital photograph being from the customer and through the intranet; and
an editor unit being connected to said central management center, said editor unit editing the digital photograph stored in said central management center, the editing being controlled by the customer through the intranet.

2. The system of claim 1, said central management center performing the generating of the user identification number of the customer in dependence upon the information transmitted from said management computer to said central management center

3. The system of claim 1, further comprising a plurality of additional access devices being installed at the lodging house and at a region affiliated with the lodging house.

4. The system of claim 3, the region corresponding to an amusement park.

5. The system of claim 4, the information transmitted by said management computer to said central management center including other data corresponding to the customer, said central management center storing the other data corresponding to the customer received from said management computer, said central management center storing the generated user identification number to correlate at least the generated user identification number with the other data corresponding to the customer.

6. The system of claim 4, further comprising a commerce unit being connected to said central management center, said commerce unit combining details of the other data corresponding to the customer with details of a request for a souvenir, the request for the souvenir being from the customer and through the intranet, the souvenir incorporating the image data, said commerce unit transmitting the combined details to an order processing system of a souvenir manufacturer corresponding to a product category of the souvenir.

7. The system of claim 1, further comprising a commerce unit being connected to said central management center, said commerce unit combining a name and address of the customer stored in said central management center with details of a request for a souvenir, the request for the souvenir being from the customer and through the intranet, the souvenir incorporating selected image data, said commerce unit transmitting the combined details to an order processing system of a souvenir manufacturer corresponding to a product category of the souvenir.

8. The system of claim 7, the selected image data incorporated by the souvenir being selected by the customer from the image data stored by said central management center.

9. The system of claim 8, said central management center receiving details on usage of products and services of the customer from said management computer through the intranet, said central management center storing the usage details to correlate the usage details with the user identification number, said central management center transmitting the usage details to said management computer through the intranet in response to a request received from said management computer through the intranet when the customer checks out of the lodging house, said management computer receiving and outputting the usage details.

10. The system of claim 9, further comprising a plurality of additional access devices being installed at the lodging house and at an amusement park affiliated with the lodging house.

11. The system of claim 10, the usage details including at least one selected from among details on usage of products and services at the lodging house, details on usage of products and services at the amusement park affiliated with the lodging house, details on the digital camera terminal, and details on the request for the souvenir.

12. A system for renting a digital camera from a lodging house having guest rooms, the system comprising:
a digital camera terminal being rented to a customer, said digital camera terminal wirelessly transmitting data including at least a terminal identification number of said digital camera terminal and including image data of a digital photograph captured by the customer, said digital camera terminal including a digital camera;
an access device receiving the wirelessly transmitted data from said digital camera terminal, said access device transmitting the data received from said digital camera terminal through an intranet;
a central management center being in communication with the intranet, said central management center receiving from the intranet the data transmitted by said access device including the terminal identification number and the image data;
a management computer transmitting information to said central management center through the intranet when the customer is assigned a guest room of the lodging house, the information including the terminal identification number and a room identification number corresponding to the guest room assigned to the customer, said central management center storing the terminal identification number and the room identification number corresponding to the guest room assigned to the customer received from said management computer, said central management center generating a user identification number of the customer, said central management center storing the generated user identification number to correlate the generated user identification number at least with the terminal identification number and with the room identification number and with the image data, said central management center transmitting the image data to a user computer through the Internet in response to a request for the digital photograph, the request for the digital photograph being from the customer and through the Internet; and
an editor unit being connected to said central management center, said editor unit editing the digital photograph stored in said central management center, the editing being controlled by the customer through the Internet.

13. The system of claim 12, further comprising a plurality of additional access devices being installed at the lodging house and at an amusement park affiliated with the lodging house.

14. The system of claim 12, further comprising a plurality of additional access devices being installed at the lodging house and at a region affiliated with the lodging house.

15. The system of claim 14, the information transmitted by said management computer to said central management center including other data corresponding to the customer, said central management center storing the other data corresponding to the customer received from said management computer, said central management center storing the generated user identification number to correlate at least the generated user identification number with the other data corresponding to the customer.

16. The system of claim 15, further comprising a commerce unit being connected to said central management center, said commerce unit combining details of the other data corresponding to the customer with details of a request for a souvenir, the request for the souvenir being from the customer and through the intranet, the souvenir incorporating the image data, said commerce unit transmitting the combined details to an order processing system of a souvenir manufacturer corresponding to a product category of the souvenir.

17. The system of claim 14, further comprising a commerce unit being connected to said central management center, said commerce unit combining a name and address of the customer stored in said central management center with details of a request for a souvenir, the request for the souvenir being from the customer and through the intranet, the souvenir incorporating selected image data, said commerce unit transmitting the combined details to an order processing system of a souvenir manufacturer corresponding to a product category of the souvenir.

18. The system of claim 17, the selected image data incorporated by the souvenir being selected by the customer from the image data stored by said central management center.

19. The system of claim 18, said central management center receiving details on usage of products and services of the customer from said management computer through the intranet, said central management center storing the usage details to correlate the usage details with the user identification number, said central management center transmitting the usage details to said management computer through the intranet in response to a request received from said management computer through the intranet when the customer checks out of the lodging house, said management computer receiving and outputting the usage details.

20. The system of claim 19, the usage details including at least one selected from among details on usage of products and services at the lodging house, details on usage of products and services at the amusement park affiliated with the lodging house, details on the digital camera terminal, and details on the request for the souvenir.

21. The system of claim 12, said central management center receiving details on usage of products and services of the customer from said management computer through the intranet, said central management center storing the usage details to correlate the usage details with the user identification number, said central management center transmitting the usage details to said management computer through the intranet in response to a request received from said management computer through the intranet when the customer checks out of the lodging house, said management computer receiving and outputting the usage details.

22. The system of claim 21, the usage details including at least one selected from among details on usage of products and services at the lodging house, details on usage of products and services at the amusement park affiliated with the lodging house, details on the digital camera terminal, and details on the request for the souvenir.

23. The system of claim 12, the information transmitted by said management computer to said central management center including other data corresponding to the customer, said central management center storing the other data corresponding to the customer received from said management computer, said central management center storing the generated user identification number to correlate at least the generated user identification number with the other data corresponding to the customer.

24. The system of claim 23, further comprising a commerce unit being connected to said central management center, said commerce unit combining details of the other data corresponding to the customer with details of a request for a souvenir, the request for the souvenir being from the customer and through the intranet, the souvenir incorporating the image data, said commerce unit transmitting the combined details to an order processing system of a souvenir manufacturer corresponding to a product category of the souvenir.

25. A method for renting a digital camera from a lodging house having guest rooms, the method comprising:
renting a digital camera terminal to a customer, said digital camera terminal having a terminal identification number;
capturing a digital photograph with said digital camera terminal;
wirelessly transmitting data including at least the terminal identification number and image data of the digital photograph;
receiving the wirelessly transmitted data at an access device;
transmitting the data from said access device through an intranet;
receiving from the intranet the data transmitted by said access device including the terminal identification number and the image data, said receiving of the data transmitted by said access device being performed by a central management center;
transmitting information from a management computer to said central management center through the intranet when the customer is assigned a guest room of a lodging house, the information including the terminal identification number and a room identification number corresponding to the guest room;
storing the terminal identification number and the room identification number corresponding to the guest room received from said management computer;
generating a user identification number of the customer; and
storing the generated user identification number to correlate the generated user identification number at least with the terminal identification number and with the room identification number and with the image data.

26. The method of claim 25, further comprising installing a plurality of additional access devices at the lodging house and at a region affiliated with the lodging house.

27. The method of claim 26, the region corresponding to an amusement park.

28. The method of claim 25, further comprising:
transmitting the image data to a user computer through the Internet in response to a request for the digital photograph, the request for the digital photograph being from the customer and through the Internet; and
editing the digital photograph stored in said central management center, said editing being controlled by the customer through the Internet.

29. The method of claim 28, further comprising installing a plurality of additional access devices at the lodging house and at a region affiliated with the lodging house.

30. The method of claim 29, the region corresponding to an amusement park.

31. The method of claim 25, further comprising:
transmitting the image data to the guest room through the intranet in response to a request for the digital photograph, the request for the digital photograph being from the customer and through the intranet; and
editing the digital photograph stored in said central management center, said editing being controlled by the customer through the intranet.

32. The method of claim 31, further comprising installing a plurality of additional access devices at the lodging house and at a region affiliated with the lodging house.

33. The method of claim 32, the region corresponding to an amusement park.

34. The method of claim 32, further comprising:
combining a name and address of the customer stored in said central management center with details of a request for a souvenir, the request for the souvenir being from the customer and through the intranet, the souvenir incorporating selected image data; and
transmitting the combined details to an order processing system of a souvenir manufacturer corresponding to a product category of the souvenir.

35. The method of claim 34, the selected image data incorporated by the souvenir being selected by the customer from the image data stored by said central management center.

36. The method of claim 35, further comprising:
receiving details on usage of products and services of the customer from said management computer through the intranet;
storing the usage details to correlate the usage details with the user identification number; and
transmitting the usage details to said management computer through the intranet in response to a request received from said management computer through the intranet when the customer checks out of the lodging house.

37. The method of claim 36, the usage details including at least one selected from among details on usage of products and services at the lodging house, details on usage of products and services at the amusement park affiliated with the lodging house, details on the digital camera terminal, and details on the request for the souvenir.
